(19) United States
(12) Patent Application Publication
(10) Pub. No.: US 2014/0271173 A1
(43) Pub. Date: Sep. 18, 2014

(54) CENTRIFUGAL COMPRESSOR WITH AXIAL IMPELLER EXIT

(71) Applicant: Rolls-Royce North American Technologies, Inc., Indianapolis, IN (US)

(72) Inventor: William B. Bryan, Indianapolis, IN (US)

(21) Appl. No.: 14/133,275

(22) Filed: Dec. 18, 2013

Related U.S. Application Data
(60) Provisional application No. 61/799,141, filed on Mar. 15, 2013.

(51) Int. Cl. F04D 29/44; F04D 17/10

(52) U.S. Cl. CPC F04D 29/441; F04D 17/10
USPC 415/211.2; 415/182.1

(57) ABSTRACT

A gas turbine engine includes a centrifugal compressor having an improved impeller structure. The impeller structure includes a near axial discharge configuration thus reducing the overall size of the envelop surrounding the compressor assembly. The impeller structure may have axial exit vanes.

### CROSS-REFERENCE TO RELATED APPLICATIONS

This application claims priority to U.S. Provisional Patent Application No. 61/799,141, filed Mar. 15, 2013, the contents of which are hereby incorporated in their entirety.

### FIELD OF TECHNOLOGY

An improved gas compressor and liquid pump, and more particularly, a centrifugal compressor with axial impeller exit that may be used with gas turbine engines, fans, turbochargers, general air compressors, refrigeration compressors, gas processing and pumping compressors and centrifugal liquid pumps.

### BACKGROUND

Gas turbine engines commonly employ multi-stage axial compressor alone, multi-stage axial compressors followed by a centrifugal compressor, or only a centrifugal compressor. This is followed by a combustor, a turbine and other components that are involved in the air stream. The compressor receives intake air which is compressed and then directed towards the combustor. The airflow is mixed with fuel and ignited by the igniter system. This process produces hot combustion gasses that are used to propel the high, medium and low pressure turbines.

As mentioned above, some gas turbine engines use a high pressure centrifugal compressor and centrifugal compressors operate differently from the above mentioned traditional axial compressors. Centrifugal compressors operate by inducing a centrifugal force to an air mass through a significant increase in radius from inlet to exit, in order to achieve increased compression which results in high pressure air be generated in large volumes. The impeller is configured to increase energy to the fluid and a diffuser is configured to convert a portion of the impeller exit kinetic energy into static pressure. The centrifugal compressor may include a diffuser that employs a radial diffuser, a bend and a de-swirler or scroll/collector. A system with such an integral assembly could provide manufacturing and cost benefits.

One of the drawbacks of centrifugal compressors, however, is that the impeller has a radial discharge, which produces a large outer diameter of the diffuser and collector relative to the inlet area. These configurations consume large spaces within the engine environment. Their envelope is sufficiently large in that they encompass very valuable space in the machinery in which such a system is employed. It would be desirable to improve this characteristic, by significantly reducing the diameter and allowing it to be utilized in a broader range of designs. It would also be desirable to provide an impeller system that improves performance relative to other centrifugal compressors. Such improvement could have the potential for application in a wide range of machinery, including, but not limited to, gas turbine engines.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates a schematic diagram of a gas turbine engine employing a standard, radial exit, centrifugal compressor; and

FIG. 2 illustrates an enlarged side sectional view of the FIG. 1 compressor, showing the improved centrifugal compressor with axial impeller exit.

### DETAILED DESCRIPTION

An exemplary gas turbine centrifugal compressor fluid path assembly includes an enhanced diffuser and impeller duct configuration. One embodiment includes an assembly having a rotating impeller housing and a stationary diffuser exit flow path. The inlet of the impeller housing is shown with a near axially extending inlet centerline, but this may deviate substantially from axial in general. The outlet of the diffuser also has an axially extending centerline, but this may also deviate substantially from axial as well as having curvature. A central rotational axis is provided with the machine.

One of the features of the improved centrifugal compressor with axial impeller exit is the compressed housing configuration that embodies reduced outer diameter ratios. Conventional centrifugal compressors are distinguished from axial compressors in that the exit has a substantially larger radius than the inlet, and the impeller exit flow is typically near radial. Since the improved centrifugal compressor has a near axial discharge, a distinguishing feature is the increase in radius from inlet to exit. This increase in radius is defined as the exit mean radius 46, which is greater than the inlet tip or maximum radius of the impeller inlet, 38. This enhanced improved configuration provides a compressed envelop and reduces the size of the engine configuration.

Another exemplary embodiment includes a reduced outer diameter of the exit vane relative to the rotational axis of the machine. Here the radial distance from the central rotational axis to the inlet centerline has a value of r. In addition, the radial distance from the central rotational axis to the outlet centerline has a value of r′. By contrast the radial distance from the central rotational axis to the standard exit centerline has a value of r″. An improvement here is that the dimension r′ for the improved design is substantially less than the dimension r″ for conventional radial diffuser designs.

Another exemplary embodiment is a centrifugal type compressor that employs an axial discharge configuration where the impeller is shaped so that the discharge is axial or near axial. This is accomplished through elimination of the radial diffuser and scroll/exit system. Such design significantly reduces the diameter of the diffuser and exit flow system.

An exemplary compressor may have one row of exit vanes or multiple rows. The impeller exit may be exactly axial or near axial. The primary feature is that the overall compressor diameter is minimally greater than the impeller diameter. The impeller diameter is approximately the same as a conventional impeller, however, the diffuser and exit system of a conventional design is much greater. The overall performance of the improved system should be similar to a centrifugal compressor with an equivalent impeller diameter, with the potential of incremental improvements beyond what is shown.

FIG. 1 illustrates a side schematic view of a gas turbine engine 10 having a compressor, an air inlet 12, an axial compressor 14, followed by a centrifugal compressor 16, a combustor 18, and a turbine 20. A rotational axis 28 centerline provides the point in which engines 10 components rotate. It will be appreciate that the improvement herein may be used in other applications where it is desirable to provide enhanced compressor/pump impeller performance.

FIG. 2 illustrates an enlarged side schematic view of the centrifugal compressor assembly 16 of the FIG. 1 engine 10. The assembly 16 includes an impeller housing 21, a first vane section 22, a second vane section 24, and an exit section 25 having an air exit port 26. The first vane section 22, a second vane section 24, and exit section 25 are joined sections and it will be appreciated that the assembly 16 may have more or fewer sections depending on the design of the machine 10. Sections 22, 24 and 25 are co-arranged relative to the air outlet centerline 32 and they collectively may have a tapered configuration as shown in FIG. 2 so that as they progress towards exit port 26 their diameters gradually increase. Such arrangement provides a smooth continuous configuration.

The air inlet centerline 30 is offset from the rotational axis 28 centerline a distance of r. The air outlet centerline 32 is offset from the rotational axis 28 centerline a distance r′. The inlet axis 30 is shown nearly axial but it will be appreciated that it could depart from an axial orientation. The air standard exit has a centerline 34 that is offset from the rotational axis 28 centerline a distance r″. The air flow inlet 38 typically extends generally perpendicular to the centerline 28, but may depart substantially in some cases. Likewise the air flow exit port 26 typically extends generally perpendicular to the centerline 28, but again may depart in some cases. Gas g from an axial compressor 14 enters inlet 38 and exits outlet 40. An average radius of the outlet 40 is greater than the maximum radius of the tip (outer diameter) of the flow inlet 38. Such configuration creates a unique envelope that is much more compact than traditional centrifugal compressor configurations.

The housing 21 has a flow path 36 that extends from the inlet 38 to the outlet 40 of the housing. A shortened radial section 42 extends from a typically axial inlet portion 44. The radial section 42 turns towards an axial 46 direction that is in alignment with the centerline 32. Thus, the outlet 40 has an opening 41 that is nearly perpendicular to the centerline 32, but it will be appreciated that it may depart from perpendicular. The axis 46 is preferably nearly parallel to the engine axis 28. The flow path 36 is the mean flow direction which is about 70 degrees maximum relative to the axis 28 of the machine, but it will be appreciated that the angle could be more or less. This represents the mean flow through the centerline 28 of the compressor which has an axial exit at 41.

The assembly 16 depicts a stationary first vane 22 connected to the outlet 40. A second stationary vane 24 is connected to the first vane 22. An exit section 25 is connected to the second vane 24. The vanes 22, 24 and exit section 25 are co-aligned along axis 32 to form a continuous stationary structure for advancing airflow towards and exit port 26 which in turn may feed compressed air to the combustor 18. It will be appreciated that the axis 32 may not be linear and could be arcuate shaped in configuration, as well as angled from an axial direction.

A diffuser section 50 and exit system vane 52 could be connected in one embodiment. See the dashed lines in FIG. 2. However in such a system, the added length of diffuser section 50 and the vane 52 inherently increases the outboard radial distance of the assembly 16 by an increased distance of d. By increasing distance d, the overall envelop of the system 16 in the engine 10 environment increases. This is due to the physical geometry of the section 50 causing the exit vane 52 to be outboard and radially offset a distance r″ from the rotational axis 28. When such an arrangement increases the envelope size of the engine compartment, valuable space is consumed that may be otherwise employed by other systems. An improvement here overcomes this dilemma by shortening the exit port to have a centerline of 32 of the distance r′ from the rotational axis 28. The exemplary embodiment disclosed substantially shortens the radial outboard distance of the exit port 26. As a result, a more confined assembly 16 is provided that utilizes a more confined envelope within the engine 10. Likewise, a centrifugal compressor 16 having substantially axial impeller exit flow is provided.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A gas turbine engine comprising:
a centrifugal compressor having a rotational axis; and
a rotating impeller structure having an inlet and a discharge, the inlet has a first central axis that may be parallel to the rotational axis or at an angle, the discharge has a central axis that is substantially parallel to the rotational axis.

2. The gas turbine engine as claimed in claim 1, further comprising at least one single row stationary vane connected to the impeller discharge.

3. The gas turbine engine as claimed in claim 1, further comprising another compressor positioned adjacent the centrifugal compressor.

4. The gas turbine engine as claimed in claim 1, further comprising a first vane that is connected to the discharge, a second vane that is connected to the first vane, and an exit member that is connected to the second vane.

5. The gas turbine engine as claimed in claim 5, wherein the exit member that is connected to the second vane has one of a longitudinally extending axis that may be substantially parallel to the rotational axis, or have a substantial angle to the rotational axis, or have a curved axis relative to the rotational axis.

6. The gas turbine engine as claimed in claim 1, further comprising an inlet flow path, and an outlet flow path, wherein one of said directions of the flow paths are axial.

7. The gas turbine engine as claimed in claim 1, wherein the impeller has an inlet port, the impeller further includes an outlet port that has a face that is close to being perpendicular to the rotational axis.

8. The gas turbine engine as claimed in claim 1, wherein airflow enters the inlet of the impeller structure in a first direction, and the airflow exits the discharge of the impeller in a second direction, said second direction is near axial.

9. A gas turbine engine comprising:
a centrifugal compressor having a rotational axis; and
an impeller housing having an axial discharge that is aligned with the rotational axis.

10. The gas turbine engine as claimed in claim 9, further comprising a centrifugal compressor with one of a single row or multiple rows of exit vanes.

11. The gas turbine as claimed in claim 9, further comprising an axially aligned impeller discharge that is substantially parallel to the rotational axis.

12. The gas turbine as claimed in claim 9, further comprising an axially aligned outlet that is near parallel to the rotational axis.

13. The gas turbine as claimed in claim 9, wherein the impeller housing has an inlet with an inlet portion that is substantially perpendicular to the rotational axis, the impeller housing further has a discharge with an outlet portion that is substantially perpendicular to the inlet portion.

14. The gas turbine as claimed in claim 9, wherein compressed gas enters the inlet of the impeller housing in a first direction, air passes through the impeller housing to where it exits at the discharge in a second direction.

15. The gas turbine as claimed in claim 9, wherein gas enters the impeller housing along a first vector, and the gas exits the impeller housing along a vector that is in substantial alignment with the rotational axis.

16. The gas turbine as claimed in claim 9, further comprising one or more rotating blades that are positioned between an inlet of the impeller housing and the discharge of the impeller housing.

17. A gas compressor for use in connection with a machine comprising:
a centrifugal compressor having an impeller discharge average radius greater than the inlet tip radius; and
an impeller system for the centrifugal compressor, the impeller system having an inlet port and an outlet port, the impeller further having near axial discharge of gas.

18. The gas compressor as claimed in claim 17, further comprising a first central axis extending through the inlet port, a second central axis extending through the outlet port, both axis are substantially parallel to one another.

19. The gas compressor as claimed in claim 17, wherein the machine is one of a gas turbine engine, a fan, a turbocharger, an air compressor, a refrigeration compressor, a gas processing and pumping compressor, or a centrifugal liquid pump.

20. The gas compressor as claimed in claim 17, further comprising another compressor located upstream for the centrifugal compressor.
